(19) United States
(12) Patent Application Publication
(10) Pub. No.: US 2022/0283584 A1
(43) Pub. Date: Sep. 8, 2022

(54) INFORMATION PROCESSING DEVICE, INFORMATION PROCESSING METHOD, AND INFORMATION PROCESSING PROGRAM

(71) Applicant: Sony Group Corporation, Tokyo (JP)

(72) Inventors: Masahiko TOYOSHI, Tokyo (JP); Kohei URUSHIDO, Tokyo (JP); Ryuta SATOH, Tokyo (JP); Takuto MOTOYAMA, Tokyo (JP)

(73) Assignee: Sony Group Corporation, Tokyo (JP)

(21) Appl. No.: 17/626,495

(22) PCT Filed: May 28, 2020
(86) PCT No.: PCT/JP2020/021124

§ 371 Date: Jan. 12, 2022

(30) Foreign Application Priority Data
Jul. 19, 2019 (JP) 2019-133622

(51) Int. Cl. G05D 1/00; H04N 5/232; G06T 7/60; G05D 1/02; G01C 21/20; G01C 21/00

(52) U.S. Cl. CPC G05D 1/0094; H04N 5/23222; H04N 5/23216; G06T 7/60; G05D 1/0202; G01C 21/20; G01C 21/3889; G06T 2207/20061

(57) ABSTRACT

An information processing device includes a map creating unit that creates a map of a travel range, which is a range over which a mobile body having an image-capturing device performs photography while travelling, a shape extracting unit that extracts a shape present in the map, a composition setting unit that sets a composition of an image to be photographed by the image-capturing device, and a route deciding unit that decides a travel route in the travel range of the mobile body on the basis of the shape and the composition.

### TECHNICAL FIELD

The present technology relates to an information processing device, an information processing method, and an information processing program.

### BACKGROUND ART

There conventionally has been proposed, in technology of photography by a camera, technology for presenting an optimal composition in accordance with a scene, subject, or the like, which a user intends to photograph (PTL 1).

Also, in recent years, autonomous mobile bodies such as drones and so forth have become commonplace, and methods of mounting cameras on autonomous mobile bodies and performing photography are also becoming commonplace.

### CITATION LIST

### Patent Literature

### [PTL 1]

JP 2011-135527 A

### SUMMARY

### Technical Problem

The technology described in PTL 1 relates to normal photography in which the position of the camera is fixed, and optimization of composition in photography by a camera mounted on an autonomously-traveling autonomous mobile body is an unresolved problem.

The present technology has been made with such a point in view, and it is an object thereof to provide an information processing device, an information processing method, and an information processing program that enable a mobile body to decide a travel route for photographing with a desired composition while autonomously traveling.

### Solution to Problem

In order to solve the above-described problem, a first technology is an information processing device, including a map creating unit that creates a map of a travel range, which is a range over which a mobile body having an image-capturing device performs photography while travelling, a shape extracting unit that extracts a shape present in the map, a composition setting unit that sets a composition of an image to be photographed by the image-capturing device, and a route deciding unit that decides a travel route in the travel range of the mobile body on the basis of the shape and the composition.

Also, a second technology is an information processing method, including creating a map of a travel range, which is a range over which a mobile body having an image-capturing device performs photography while travelling, extracting a shape present in the map, setting a composition of an image to be photographed by the image-capturing device, and deciding a travel route in the travel range of the mobile body on the basis of the shape and the composition.

Also, a third technology is an information processing program that causes a computer to execute an information processing method of creating a map of a travel range, which is a range over which a mobile body having an image-capturing device performs photography while travelling, extracting a shape present in the map, setting a composition of an image to be photographed by the image-capturing device, and deciding a travel route in the travel range of the mobile body on the basis of the shape and the composition.

### BRIEF DESCRIPTION OF DRAWINGS

FIG. 1 is an overall view illustrating a configuration of a photography system 10.

FIG. 2 is external views illustrating a configuration of a mobile body 100.

FIG. 3 is a block diagram illustrating the configuration of the mobile body 100.

FIG. 4 is a block diagram illustrating a configuration of an image-capturing device 200.

FIG. 5 is a block diagram illustrating a configuration of a terminal device 300.

FIG. 6 is a block diagram illustrating a configuration of an information processing device 400.

FIG. 7 is a flowchart illustrating an overall flow of travel route deciding.

FIG. 8 is diagrams illustrating an example of a semantic map.

FIG. 9 is an explanatory diagram of shape extraction from the semantic map.

FIG. 10 is a flowchart illustrating semantic map creation processing.

FIG. 11 is an explanatory diagram of setting a map creation range.

FIG. 12 is a flowchart illustrating travel route deciding processing.

FIG. 13 is an explanatory diagram of waypoint setting.

FIG. 14 is a flowchart illustrating local travel route deciding processing.

FIG. 15 is a flowchart illustrating cost calculation processing regarding a travel route.

FIG. 16 is explanatory diagrams for cost calculation, in which FIG. 16A is an example of the semantic map, and FIG. 16B is an example of a composition.

FIG. 17 is an explanatory diagram of cost calculation, and is a diagram illustrating a state in which the semantic map and the composition are overlaid.

FIG. 18 is an explanatory diagram of a modification in which a composition is set between each waypoint.

### DESCRIPTION OF EMBODIMENTS

An embodiment of the present technology will be described below, with reference to the drawings. Note that description will be made according to the following order.

### <1. Embodiment>

### [1-1. Configuration of Photography System 10]

### [1-2. Configuration of Mobile Body 100]

### [1-3. Configuration of Image-Capturing Device 200]

### [1-4. Configuration of Terminal Device 300 and Information Processing Device 400]

### [1-5. Processing by Information Processing Device 400]

### [1-5-1. Overall Processing]

### [1-5-2. Semantic Map Creation Processing]

### [1-5-3. Travel Route Deciding Processing]

### <2. Modifications>

### 1. Embodiment

### [1-1. Configuration of Photography System 10]

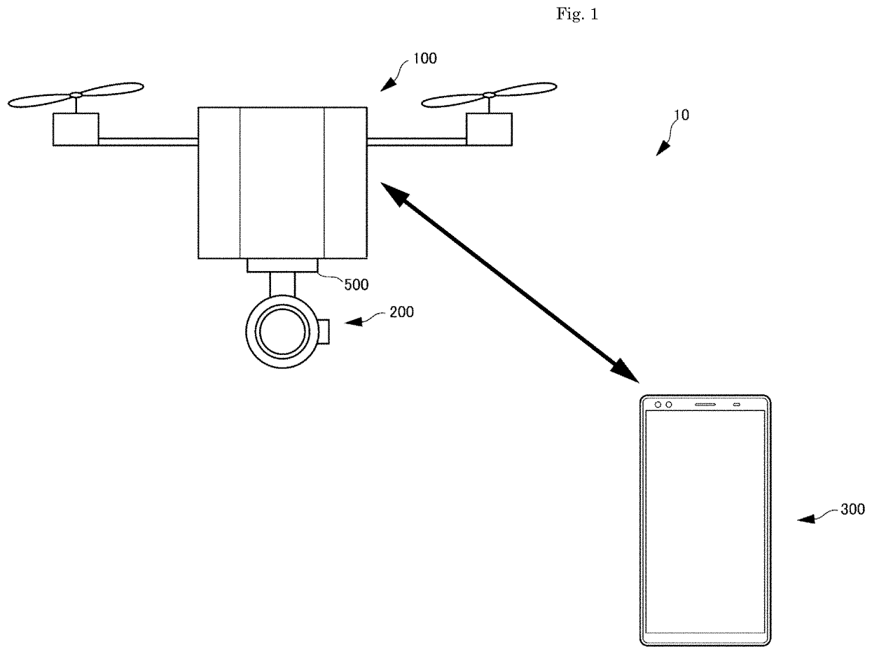

First, a configuration of a photography system 10 will be described with reference to FIG. 1. The photography system 10 is configured of a mobile body 100, an image-capturing device 200, and a terminal device 300 that has functions of an information processing device 400.

The mobile body 100 according to the present embodiment is an electric small-size aircraft (unmanned aerial vehicle) called a drone. The image-capturing device 200 is mounted to the mobile body 100 through a gimbal 500, and acquires still images/moving images by performing autonomous photography according to a composition set in advance, while the mobile body 100 is autonomously traveling.

The terminal device 300 is a computer such as a smartphone or the like that a user using the photography system 10 on the ground uses, and the information processing device 400 running in the terminal device 300 performs setting of composition in photography, creation of travel routes of the mobile body 100, and so forth.

The mobile body 100 is capable of communication with the image-capturing device 200 by wired or wireless connection. Also, the terminal device 300 and the mobile body 100 and image-capturing device 200 are capable of communication by wireless connection.

### [1-2. Configuration of Mobile Body 100]

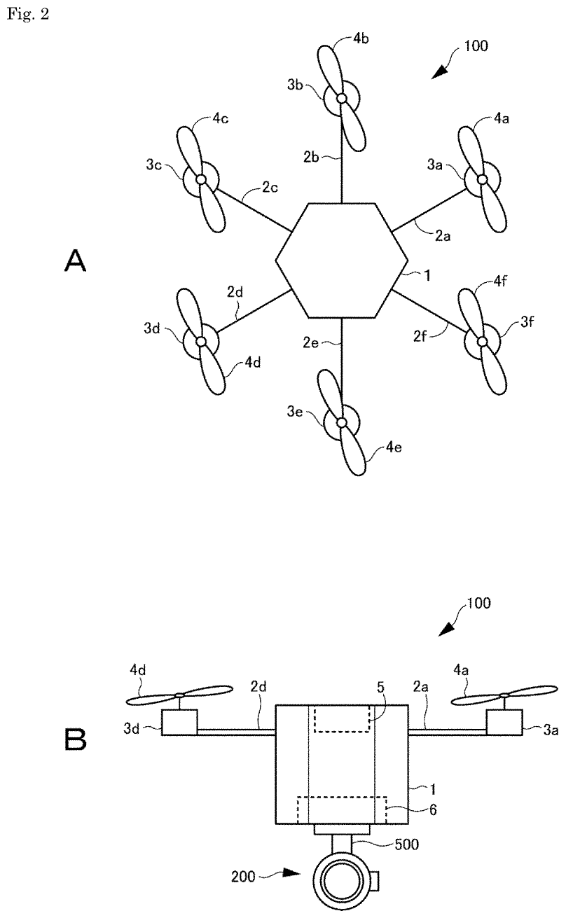

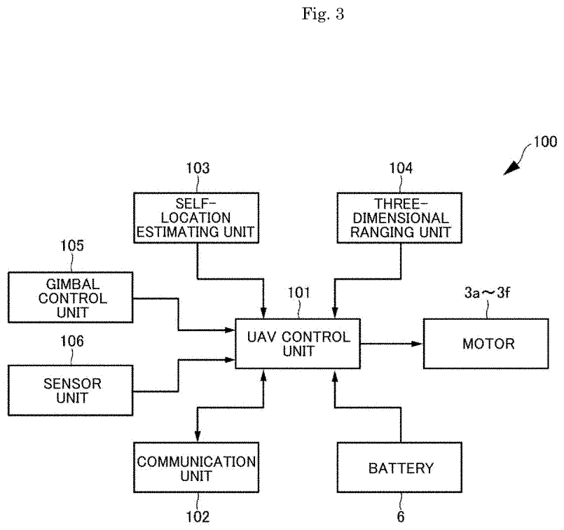

The configuration of the mobile body 100 will be described with reference to FIG. 2 and FIG. 3. FIG. 2A is an external plan view of the mobile body 100, and FIG. 2B is an external frontal view of the mobile body 100. An airframe is made up of a fuselage 1 having a cylindrical form or polygonal tube form as a central portion, for example, and supporting shafts 2a to 2f fixed on the upper portion of the fuselage 1. As one example, the fuselage 1 is a hexangular tube with six supporting shafts 2a to 2f radially extending at equal intervals from the center of the fuselage 1. The fuselage 1 and the supporting shafts 2a to 2f are configured of a lightweight and strong material.

Further, the forms, layout, and so forth, of various components of the airframe made up of the fuselage 1 and the supporting shafts 2a to 2f, are designed so that the center of gravity is situated on a vertical line passing through the center of the supporting shafts 2a to 2f. Further, a circuit unit 5 and a battery 6 are provided within the fuselage 1 so that the center of gravity is situated on this vertical line.

In the example in FIG. 2, the number of propellers and motors is six. However, a configuration in which the number of propellers and motors is four, or a configuration having eight or more propellers and motors, may be made.

Motors 3a to 3f, serving as drive sources of the propellers, are respectively attached to the tip portions of the supporting shafts 2a to 2f. Propellers 4a to 4f are attached to rotary shafts of the motors 3a to 3f. The circuit unit 5 including a UAV control unit 101 for controlling the motors, and so forth, is attached to the center portion where the supporting shafts 2a to 2f intersect.

The motor 3a and the propeller 4a, and the motor 3d and the propeller 4d, make up a pair. In the same way, (motor 3b, propeller 4b) and (motor 3e, propeller 4e) make up a pair, and (motor 3c, propeller 4c) and (motor 3f, propeller 40 make up a pair.

The battery 6, serving as a power source, is disposed on a bottom face inside the fuselage 1. The battery 6 has a lithium-ion secondary battery, for example, and a battery control circuit that controls charging and discharging. The battery 6 is detachably attached inside the fuselage 1. Matching the center of gravity of the battery 6 with the center of gravity of the airframe increases the stability of center of gravity.

Electric small-size aircrafts commonly called drones enable desired flight by controlling the output of the motors. For example, in a hovering state of being stationary in air, tilt is detected using a gyro sensor installed in the airframe, and the airframe is maintained horizontal by increasing the output of motors on the side of the airframe that is lower, and reducing the output of motors on the higher side. Further, when advancing, the output of the motors in the direction of travel is reduced and the output of the motors in the opposite direction is increased to assume a forward-inclined attitude, thereby generating propulsion in the direction of travel. In attitude control and propulsion control of such an electric small-size aircraft, the installation position of the battery 6 described above realizes balance between stability of the airframe and ease of control.

FIG. 3 is a block diagram illustrating the configuration of the mobile body 100. The mobile body 100 is configured including a UAV (unmanned aerial vehicle) control unit 101, a communication unit 102, a self-location estimating unit 103, a three-dimensional ranging unit 104, a gimbal control unit 105, a sensor unit 106, the battery 6, and the motors 3a to 3f. Note that the supporting shafts, propellers, and so forth, described above in the external view of the configuration of the mobile body 100 will be omitted. The UAV control unit 101, the communication unit 102, the self-location estimating unit 103, the three-dimensional ranging unit 104, the gimbal control unit 105, and the sensor unit 106 are included in the circuit unit 5 illustrated in the external view of the mobile body 100 in FIG. 2.

The UAV control unit 101 is configured of a CPU (Central Processing Unit), RAM (Random Access Memory), and ROM (Read Only Memory) and so forth. The ROM stores programs and so forth that are read and run by the CPU. The RAM is used as work memory of the CPU. The CPU controls the entire mobile body 100 and the individual parts by executing various types of processing and issuing commands following programs stored in the ROM. The UAV control unit 101 also controls flight of the mobile body 100 by controlling the output of the motors 3a to 3f.

The communication unit 102 is various types of communication terminals or communication modules for exchanging data with the terminal device 300 and the image-capturing device 200. Communication with the terminal device 300 is performed by wireless communication such as wireless LAN (Local Area Network) or WAN (Wide Area Network), Wi-Fi (Wireless Fidelity), 4G (fourth-generation mobile communication system), 5G (fourth-generation mobile communication system), Bluetooth (registered trademark), ZigBee (registered trademark), or the like. Communication with the image-capturing device 200 may be wired communication such as USB (Universal Serial Bus) communication or the like, besides wireless communication. The mobile body 100 receives travel route information created by the information processing device 400 of the terminal device 300 by the communication unit, and autonomously travels and performs photography following the travel route.

The self-location estimating unit 103 performs processing of estimating the current position of the mobile body 100 on the basis of various types of sensor information acquired by the sensor unit 106.

The three-dimensional ranging unit 104 performs three-dimensional ranging processing on the basis of various types of sensor information acquired by the sensor unit 106.

The gimbal control unit 105 is a processing unit that controls actions of the gimbal 500 that rotatably mounts the image-capturing device 200 on the mobile body 100. The orientation of the image-capturing device 200 can be freely adjusted by controlling the rotations of the axes of the gimbal 500 by the gimbal control unit 105. Accordingly, the orientation of the image-capturing device 200 can be adjusted in accordance with the set composition to perform photography.

The sensor unit 106 is a sensor that can measure distance, such as a stereo camera, LiDAR (Laser Imaging Detection and Ranging), or the like. A stereo camera is a type of ranging sensor, and is a stereo-system camera of two cameras, left and right, applying the principle of triangulation when humans view objects. Disparity data is generated using image data photographed by the stereo camera, and the distance between the camera (lens) and the object surface can be measured. LiDAR measures scattered light as to laser emission of light in pulses, and analyzes the distance to an object at a far distance, and the nature of the object. Sensor information acquired by the sensor unit 106 is supplied to the self-location estimating unit 103 and the three-dimensional ranging unit 104 of the mobile body 100.

The sensor unit 106 may also include a GPS (Global Positioning System) module or an IMU (Inertial Measurement Unit) module. A GPS module acquires the current position (latitude and longitude information) of the mobile body 100, and supplies to the UAV control unit 101, the self-location estimating unit 103, and so forth. The IMU module is an inertia measuring device, which detects the attitude, tilt, angular velocity when turning, angular velocity about the Y axis direction, and so forth, of the mobile body 100, by finding three-dimensional angular velocity and acceleration by an acceleration sensor regarding biaxial or triaxial directions, an angular velocity sensor, a gyro sensor, and so forth, which are supplied to the UAV control unit 101 and the like.

The sensor unit 106 may further include an altimeter, a compass, and so forth. The altimeter measures the altitude at which the mobile body 100 is positioned, and supplies altitude data to the UAV control unit 101. There are pressure altimeters, radio altimeters, and so forth. A compass detects the direction of travel of the mobile body 100 using functions of a magnet, which is supplied to the UAV control unit 101 and the like.

In the present embodiment, the image-capturing device 200 is mounted at the lower portion of the mobile body 100 by the gimbal 500. The gimbal 500 is a type of swivel that rotates an object (the image-capturing device 200 in the present embodiment) supported on biaxial or triaxial axes, for example.

### [1-3. Configuration of Image-Capturing Device 200]

The image-capturing device 200 is mounted to the bottom face of the fuselage 1 of the mobile body 100, being suspended by the gimbal 500, as illustrated in FIG. 2B. The image-capturing device 200 can perform photography by directing the lens in all directions from 360-degree horizontal directions to the vertical direction, by driving of the gimbal 500. This enables photography according to a set composition. Note that driving control of the gimbal 500 is performed by the gimbal control unit 105.

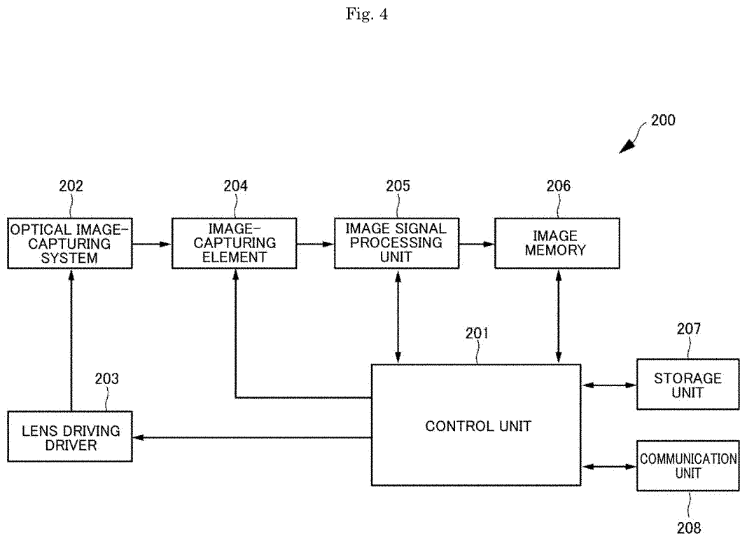

The configuration of the image-capturing device 200 will be described with reference to the block diagram in FIG. 4. The image-capturing device 200 is configured including a control unit 201, an optical image-capturing system 202, a lens driving driver 203, an image-capturing element 204, an image signal processing unit 205, image memory 206, a storage unit 207, and a communication unit 208.

The optical image-capturing system 202 is configured of an image-capturing lens that collects light from a subject on the image-capturing element 204, a driving mechanism that moves the image-capturing lens to perform focusing and zooming, a shutter mechanism, an iris mechanism, and so forth. These are driven on the basis of control signals from the control unit 201 and the lens driving driver 203 of the image-capturing device 200. A light image of the subject obtained through the optical image-capturing system 202 is imaged on the image-capturing element 204 that the image-capturing device 200 is provided with.

The lens driving driver 203 is configured of a microcontroller or the like, for example, and performs autofocusing so as to be focused on a target subject, by moving the image-capturing lens by a predetermined amount along an optical axis direction, following control of the control unit 201. Also performed thereby is control of operations of the driving mechanism, shutter mechanism, iris mechanism, and so forth of the optical image-capturing system 202, following control of the control unit 201. Thus, adjustment of exposure time (shutter speed), adjustment of the aperture value (f-number) and so forth, are performed.

The image-capturing element 204 converts incident light from the subject into charge amounts by photoelectrical conversion, and outputs pixel signals. The image-capturing element 204 then outputs the pixel signals to the image signal processing unit 205. A CCD (Charge Coupled Device), a CMOS (Complementary Metal Oxide Semiconductor), or the like is used as the image-capturing element 204.

The image signal processing unit 205 performs sample-and-hold by CDS (Correlated Double Sampling) processing to maintain a good S/N (Signal/Noise) ratio, AGC (Auto Gain Control) processing, A/D (Analog/Digital) conversion, and so forth, on image-capturing signals output from the image-capturing element 204, and creates image signals.

The image memory 206 is buffer memory configured of volatile memory, such as DRAM (Dynamic Random Access Memory) for example. The image memory 206 is for temporarily storing image data subjected to predetermined processing by the image signal processing unit 205.

The storage unit 207 is, for example, a large-capacity storage medium such as a hard disk, USB flash memory, an SD memory card, or the like. The captured image is saved in a compressed state or a non-compressed state, on the basis of a standard such as, for example, JPEG (Joint Photographic Experts Group) or the like. Also, EXIF (Exchangeable Image File Format) data including imparted information, such as information relating to saved images, image-capturing position information indicating image-capturing positions, image-capturing time information indicating the date and time of image-capturing, is also saved correlated with the image.

The communication unit 208 is various types of communication terminals or communication modules, for exchanging data with the mobile body 100 and the terminal device 300. Communication may be either wired communication such as USB communication or the like, or wireless communication such as wireless LAN, WAN, Wi-Fi, 4G, 5G, Bluetooth (registered trademark), ZigBee (registered trademark), or the like.

### [1-4. Configuration of Terminal Device 300 and Information Processing Device 400]

The terminal device 300 is a computer such as a smartphone or the like, and is provided with functions of the information processing device 400. Note that the terminal device 300 may be any sort of device such as a personal computer, a tablet terminal, a server device, or the like, besides a smartphone, as long as capable of being provided with the functions of the information processing device 400.

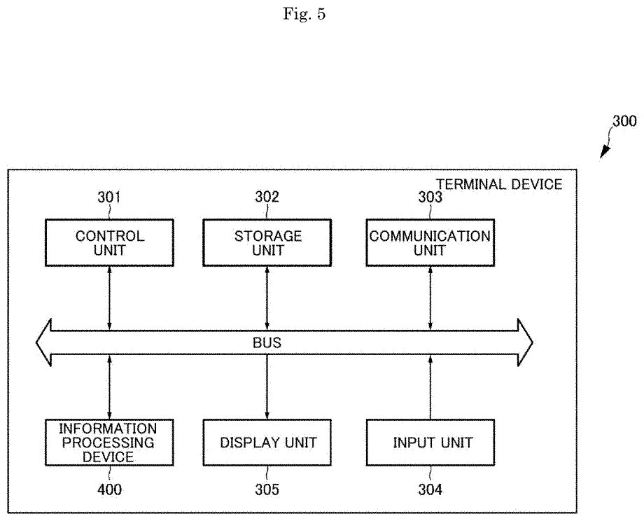

The configuration of the terminal device 300 will be described with reference to FIG. 5. The terminal device 300 is configured being provided with a control unit 301, a storage unit 302, a communication unit 303, an input unit 304, a display unit 305, and the information processing device 400.

The control unit 301 is configured of a CPU, RAM, and ROM, and so forth. The CPU controls the overall terminal device 300 and the individual parts thereof by executing various types of processing and issuing commands following programs stored in the ROM.

The storage unit 302 is, for example, a large-capacity storage medium such as a hard disk, flash memory, or the like. The storage unit 302 stores various types of applications, data, and so forth, used by the terminal device 300.

The communication unit 303 is a communication module for exchanging data and various types of information with the mobile body 100 and the image-capturing device 200. Communication may be any sort of system, as long as wireless communication such as wireless LAN, WAN, Wi-Fi, 4G, 5G, Bluetooth (registered trademark), ZigBee (registered trademark), or the like, as long as capable of communicating with the mobile body 100 and the image-capturing device 200 at distances.

The input unit 304 is for a user to perform input for composition settings, various types of input such as setting waypoints, input of instructions, and so forth. When input is made to the input unit 304 by the user, control signals corresponding to the input are generated and supplied to the control unit 301. The control unit 301 then performs various types of processing corresponding to the control signals. The input unit 304 may be, other than physical buttons, a touchscreen in which a touch panel and a monitor are integrally configured, audio input by speech recognition, and so forth.

The display unit 305 is a display device, such as a display that displays image/video, a GUI (Graphical User Interface), and so forth. In the present embodiment, a semantic map creation range setting UI, a waypoint input UI, a travel route presenting UI, and so forth, are displayed on the display unit 305. Note that the terminal device 300 may be provided with a speaker or the like that outputs audio, as output means other than the display unit 305.

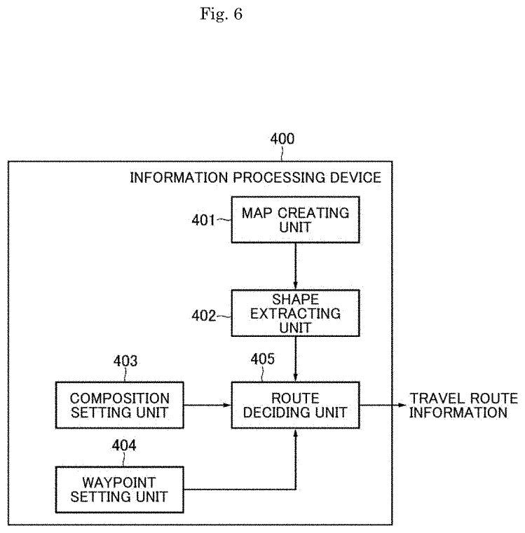

Next, the configuration of the information processing device 400 will be described. The information processing device 400 performs processing of setting compositions and deciding travel routes, so as to be able to perform autonomous travel and autonomous photograph with specified compositions by the mobile body 100 and the image-capturing device 200. The information processing device 400 is configured including a map creating unit 401, a shape extracting unit 402, a composition setting unit 403, a waypoint setting unit 404, and a route deciding unit 405, as illustrated in FIG. 6.

The map creating unit 401 creates a semantic map. Semantic is translated as “of meaning, of significance of a word, of semasiology, semasiological”, and a semantic map is a map that includes information as meaning for distinguishing and identifying objects present in the map, and information of boundary lines between objects and objects that have meaning.

The map creating unit 401 creates a semantic map regarding a range set on two-dimensional map data. The range regarding which this semantic map is created is the range over which the mobile body 100 provided with the image-capturing device 200 travels while performing photography, and is equivalent to “travel range” in the Claims.

The shape extracting unit 402 performs processing of extracting particular shapes (straight lines, curves, etc.) from the semantic map. The shape extracting unit 402 performs extraction of shapes by Hough transform, for example. Shape information indicating extracted shapes is supplied to the route deciding unit 405. Hough transform is a technique of extracting shapes, which are templates set in advance, such as straight lines with angles, circles, and so forth, from an image.

The composition setting unit 403 performs processing of setting the composition of images to be photographed by the image-capturing device 200. A first setting method for a composition is to hold a plurality of pieces of composition data in advance, present these to the user by displaying on the display unit 305 of the terminal device 300, and set a composition selected by the user as the composition for photography. There are various compositions to be held in the composition setting unit 403 in advance, such as for example, a middle placement composition that conventionally is widely used in photography, a rule-of-seconds composition, a rule-of-thirds composition, a diagonal composition, a symmetry composition, a radial composition, a triangular composition, and so forth.

Also, as a second method, there is a method in which the composition is set by drawing input by the user, instead of an existing composition. For example, a drawing UI is displayed on the display unit 305 of the terminal device 300, the user draws lines indicating a composition using a drawing tool, and shapes represented by the lines become the composition.

Further, as a third method, there is a method in which the route deciding unit 405 proposes an optimal composition for photography to the user. This is a method in which extracted shapes and a plurality of pieces of composition data held in advance are compared, using information of shapes extracted by the shape extracting unit 402, a composition with a high degree of similarity is presented and proposed to the user, and the one that the user decides on is set as the composition.

The waypoint setting unit 404 sets waypoints making up the travel route of the mobile body 100. A waypoint is a route point for the mobile body 100 that decides a travel route, indicating how the mobile body 100 will travel. A plurality of waypoints are set, since the travel route is decided thereby, and there is no particular limit to the number thereof, as long as a plurality. For example, two-dimensional map data is displayed on the display unit 305 of the terminal device 300, and points specified by the user are set as waypoints on the map. The waypoints may be set on the semantic map, or may be set on the two-dimensional map data indicating the semantic map creation range. Further, the waypoints may be specified on a map obtained by converting the semantic map into a two-dimensional bird's-eye view.

The route deciding unit 405 decides a route for the mobile body 100 to travel over within the semantic map creation range, to perform photography by the image-capturing device 200 according to the set composition. The travel route includes one global travel route that passes through all waypoints set in the semantic map creation range, and local travel routes that are travel routes among each of the waypoints.

The terminal device 300 and the information processing device 400 are configured as described above. Note that the information processing device 400 may be realized by executing a program, and the program may be installed within the terminal device 300 in advance, or may be distributed by way of downloading, a storage medium, or the like, and installed by the user themself. Further, the information processing device 400 may be realized by a combination of dedicated devices, circuits, and so forth, that are hardware having the functions thereof instead of being realized by a program.

### [1-5. Processing by Information Processing Device 400]

### [1-5-1. Overall Processing]

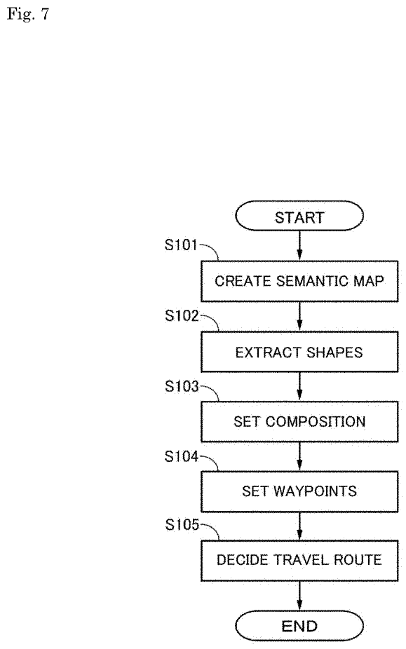

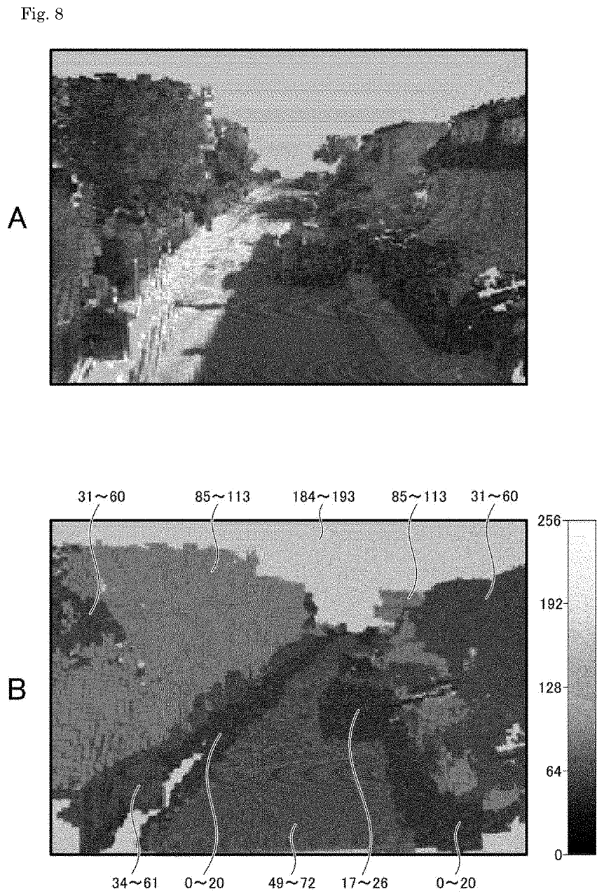

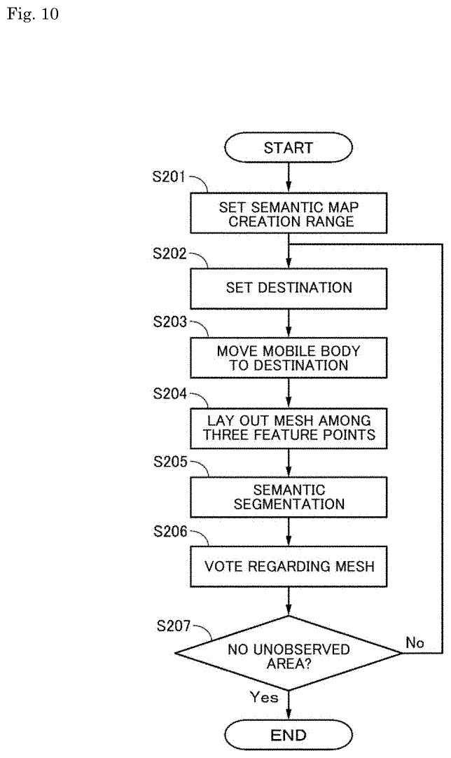

Overall processing by the information processing device 400 will be described next. FIG. 7 is a flowchart illustrating overall flow by the information processing device 400. First, in step S101, a semantic map is created by the map creating unit 401. In a case in which an original image is that illustrated in FIG. 8A, for example, the semantic map is created such as that illustrated in FIG. 8B. The semantic map in FIG. 8B is expressed in grayscale, and the values in the Figure indicating each region classified by lightness indicate the range of the grayscale gradient of that region. The semantic map in FIG. 8B also includes information meaning, for example, roads, trees, sky, and so forth in the map. Details of semantic map creation will be described later with reference to the flowchart in FIG. 10. The created semantic map is supplied to the shape extracting unit 402.

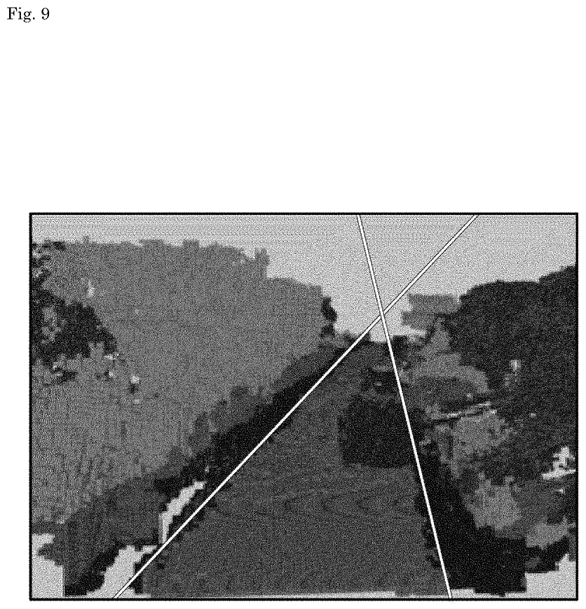

Next, in step S102, the shape extracting unit 402 extracts predetermined shapes (straight lines, curves, and so forth) from the semantic map. Shapes are extracted by Hough transform, such as illustrated in FIG. 9, for example. The information of the extracted shapes is supplied to the route deciding unit 405.

Next, the composition for photography is set by the composition setting unit 403 in step S103. The information of the composition set by the composition setting unit 403 is supplied to the route deciding unit 405.

Next, in step S104, waypoints for deciding the travel route are set by the waypoint setting unit 404.

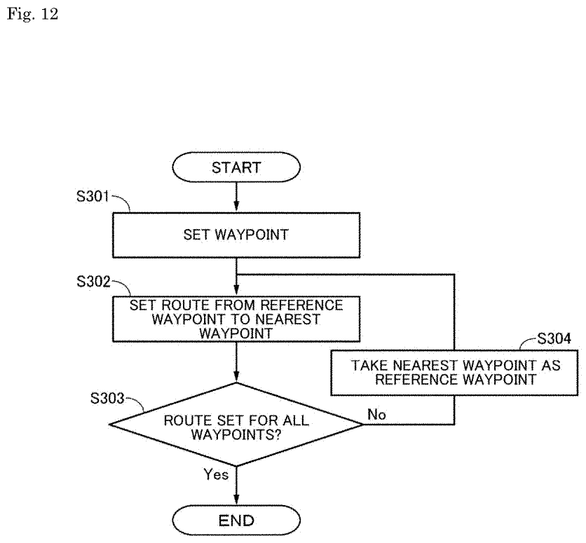

Next, in step S105, the travel route is decided by the route deciding unit 405. Details of the travel route decision will be described later with reference to the flowchart in FIG. 12. Note that the composition setting of step S103 and the waypoint setting of step S104 may be performed before the semantic map creation of step S101 and the shape extraction of step S102. It is sufficient for step S101 through step S104 to be completed by the time of performing the route decision in step S105, regardless of the order.

The information of the travel route decided in this way is supplied to the UAV control unit 101 of the mobile body 100, the UAV control unit 101 of the mobile body 100 performs control to cause autonomous travel of the mobile body 100 along the travel route, and the image-capturing device 200 performs photography according to the set composition on the travel route.

### [1-5-2. Semantic Map Creation Processing]

The semantic map creation processing in step S101 in FIG. 7 will be described first with reference to the flowchart in FIG. 10.

First, the range for creating the semantic map is decided in step S201. This semantic map creation range is set on the basis of a range specified by the user on two-dimensional map data.

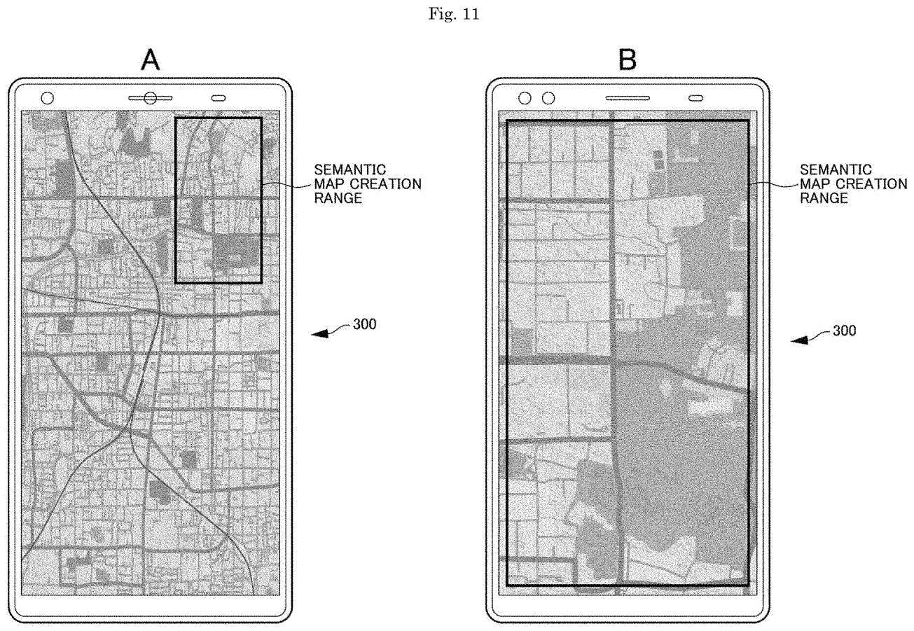

For example, on two-dimensional map data correlated with latitude and longitude information, displayed on the display unit 305 of the terminal device 300 as illustrated in FIG. 11A the user specifies a range for creating a semantic map by surrounding with a rectangular frame. Information of the specified range is then supplied to the map creating unit 401, and the specified range is set as the range for which to create the semantic map. After setting the semantic map creation range, the semantic map creation range is preferably displayed on the full range of the display unit 305 as illustrated in FIG. 11B, to facilitate specification of waypoints by the user in the semantic map creation range.

Note that the semantic map creation range is not limited to being a rectangular shape, and may be a triangular shape, a circular shape, or a free shape that is not any particular shape. Also, the map creation range may be decided by the user instructing a range on three-dimensional map data.

Next, in step S202, a destination is set for the mobile body 100 to travel to and arrive at, in order to perform observation for semantic map creation by the sensor unit 106 in the semantic map creation range. This destination is set on a boundary between an observed area where observation by the mobile body 100 is completed, and an unobserved area where observation has not been performed yet.

Next, in step S203, actions of the mobile body 100 are controlled to travel to the designation. Next, in step S204, three feature points are identified by known three-dimensional shape measurement technology using the sensor unit 106 (stereo camera, etc.) that the mobile body 100 is provided with, and a mesh is laid out among the three points. Thus, in the present embodiment, the semantic map is created using a mesh. Note that the semantic map can be created using voxels for example, not just a mesh.

Next, in step S204, semantic segmentation is performed. Semantic segmentation is processing of labeling each individual pixel making up the image regarding the meaning that the pixel indicates.

Next, in step S205, what sort or category (roads, buildings, etc.) that the mesh laid out in step S203 belongs to is decided by voting on a three-dimensional segmentation map in which the two-dimensional semantic labels on the three-dimensional shapes are projected, on the basis of the semantic segmentation results.

Next, in step S207, determination is made regarding whether or not there is an unobserved area within the semantic map creation range. In a case in which there is an unobserved area, the processing advances to step S202, and a new destination is set in step S202. Step S202 through step S207 are repeated until there are no more unobserved areas, whereby a semantic map of the entire semantic map creation range can be created.

Thus, the semantic map is created by the map creating unit 401.

### [1-5-3. Travel Route Deciding Processing]

Next, the travel route deciding processing in step S103 in the flowchart in FIG. 7 will be described with reference to the flowchart in FIG. 12. The travel route is configured of a global travel route and local travel routes. The global travel route is a route from the start point to the end point of the travel of the mobile body 100, set so as to pass over all waypoints, and the local travel routes are travel routes set between each waypoint. The global travel route is configured as a series of the local travel routes.

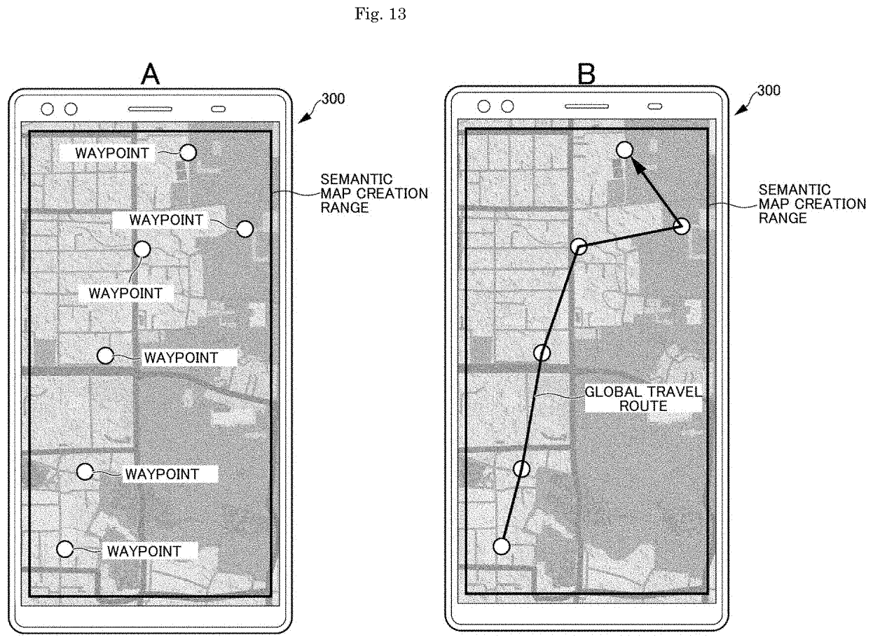

First, in step S301, the waypoint setting unit 404 sets waypoints within the semantic map creation range on the basis of input from the user. Waypoints indicate particular positions on the travel route of the mobile body 100. Waypoints set on the basis of user input are preferably represented by the above points on two-dimensional map data indicating the semantic map creation range as illustrated in FIG. 13A, for example. Thus, the user can readily confirm where the waypoints are. A plurality of waypoints are set on the semantic map creation range, as illustrated in FIG. 13A. Note that an arrangement may be made where waypoints can be specified on a semantic map, or can be specified on a map obtained by converting the semantic map into a two-dimensional bird's-eye view.

Next, in step S302, the route deciding unit 405 sets the travel route from a reference waypoint to the nearest waypoint. The initial reference waypoint is a position where travel of the mobile body 100 starts, and is set on the basis of input by the user. Note that an arrangement may be made in which the initial reference waypoint is set by the route deciding unit 405 according to a predetermined algorithm or the like.

Next, in step S303, determination is made regarding whether or not the travel route has been set so as to pass over all waypoints. In a case in which not all waypoints are passed over, the processing advances to step S304 (No in step S303).

Next, in step S304, the nearest waypoint set for the travel route in step S302 is set as the reference waypoint on the route to be set next. The processing then advances to step S302, and in step S304 the travel route is set from the newly-set reference waypoint to the nearest waypoint.

A global travel route that goes through all waypoints, as illustrated in FIG. 13B, can be set by repeating step S302 through step S304 here. Thus, the global travel route is created so as to pass over all waypoints.

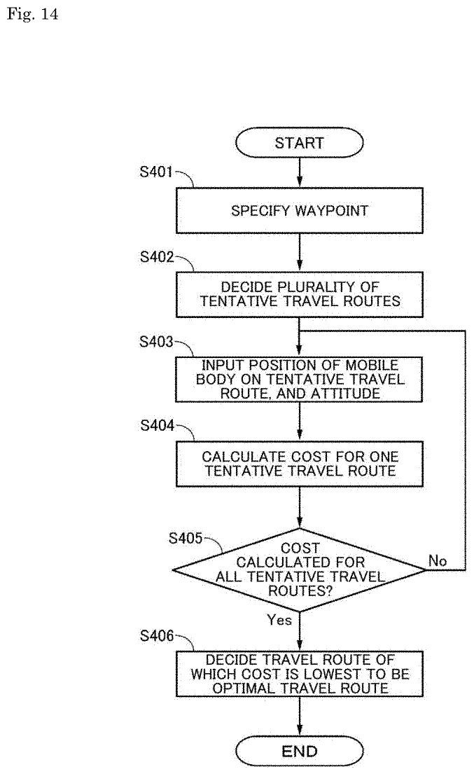

Next, the processing of setting local travel routes that are travel routes between two waypoints will be described with reference to the flowchart in FIG. 14.

First, in step S401, two waypoints for which to decide a local travel route are decided from all waypoints. The two waypoints for which to decide a local travel route may be decided from user input, or may be automatically decided in the order of waypoints corresponding to the start point through the end point of the global travel route.

Next, in step S402, the route deciding unit 405 sets a plurality of tentative travel routes between two waypoints. The way of deciding the tentative travel routes may be known technology and known algorithms that exist regarding traveling of robots, autonomous vehicles, autonomous mobile bodies, and so forth, which are efficient arrangements, arrangements for finding optimal routes, and so forth, and these may be used as appropriate depending on the situation. These known technologies can be generally classified into two, which are evaluating all conceivable routes, and selecting from a plurality of randomly-generated routes.

Next, in step S403, position of the mobile body 100 on the tentative travel route and the attitude are input. The cost of this input position of the mobile body 100 and the attitude is calculated in the following processing.

Next, in step S404, a cost is calculated for one tentative travel route out of the plurality of tentative travel routes. The cost is obtained by calculated from the results of adding a value obtained by normalizing the distance of the tentative travel route itself, a value in which a distance from an obstacle is normalized, and a value in which similarity to a composition is normalized, each of which are weighted. The travel route of which the cost is the lowest is the optimal travel route for the mobile body 100, and ultimately will be included in the global travel route. Details of cost calculation will be described later.

Next, in step S405, whether or not the cost has been calculated for all tentative travel routes is determined. In a case in which the cost has not been calculated for all tentative travel routes, the processing advances to step S403 (No in step S405), and all of step S403 through step S405 is repeated until the cost is calculated for all tentative travel routes.

In a case in which the cost has been calculated for all tentative travel routes, the processing then advances to step S406, and the tentative travel route of which the cost is lowest from all tentative travel routes is decided to be the travel route included in a route plan. A travel route that has the lowest cost and that is optimal is a travel route of which the distance of the route itself is short, and the similarity to the composition of the semantic map is high.

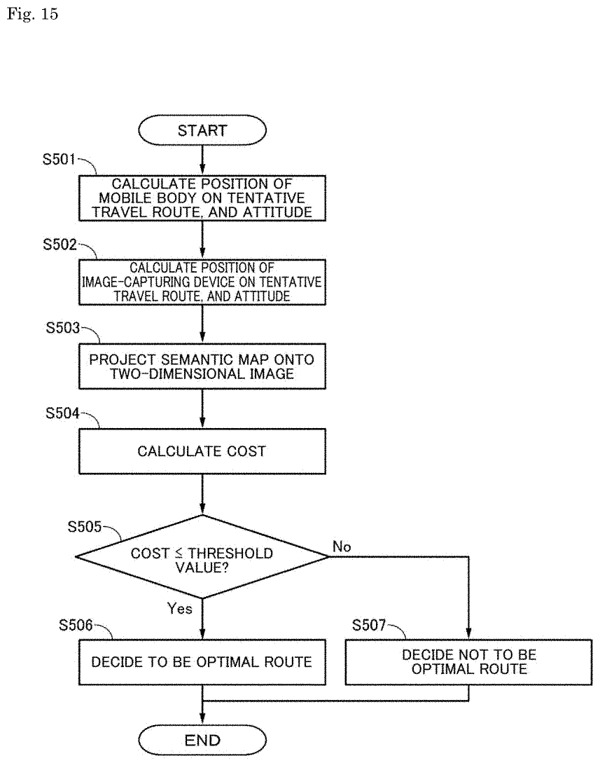

Next, calculation of cost regarding tentative travel routes will be described with reference to the flowchart in FIG. 15. The processing in FIG. 15 is for calculating costs for each of the tentative travel routes, and deciding the tentative travel route that has the lowest cost out of the plurality of tentative travel routes to be the optimal local travel route, before the actual photography.

First, in step S501, the position and the attitude of the mobile body 100 in a case of performing photography with the set composition are found regarding one tentative travel route out of the plurality of tentative travel routes.

Next, in step S502, the position and the attitude of the image-capturing device 200 in a case of performing photography with the set composition are found regarding the one tentative travel route. Note that the position and the attitude of the image-capturing device 200 may be found as the position and the attitude of the gimbal 500.

Next, in step S503, a photographed image that can be assumed to be capable of being photographed by the image-capturing device 200 is acquired from the semantic map, on the basis of the position and the attitude of the mobile body 100 calculated in step S501 and the position and the attitude of the image-capturing device 200 calculated in step S502. This processing can be said to be processing in which what sort of image can be taken in three-dimensional space when performing photography by the image-capturing device 200 provided to the mobile body 100 on the three-dimensional semantic map is expressed two-dimensionally, and converted into a photographed image assumed to be able to be photographed of the semantic map by the image-capturing device 200, i.e., processing of projecting the semantic map onto a two-dimensional image as a photographed image.

A two-dimensional image that is predicted to be photographed in a case in which the mobile body 100 is at a particular position and attitude along the tentative travel route and also the image-capturing device 200 provided to the mobile body 100 is at a particular position and attitude thereat, is compared with the three-dimensional map and calculated. The processing in this step S503 is not actually performing photography with the image-capturing device 200, but calculating on the basis of the semantic map, the position information and the attitude information of the mobile body 100, and the position information and the attitude information of the image-capturing device 200, by processing within the information processing device 400.

Next, in step S504, the cost of the tentative travel route is calculated. The costcomp k that is the cost relating to the semantic map and the composition, which is the difference between the line segments making up the set composition and the shapes (straight lines, curves, etc.) extracted in the semantic map, is calculated from the following Expression 1.

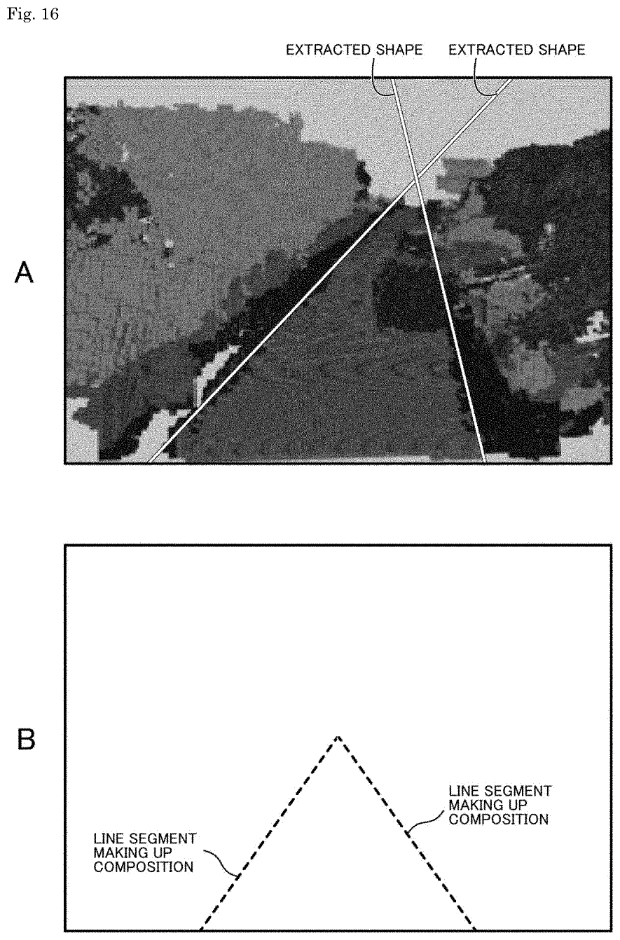

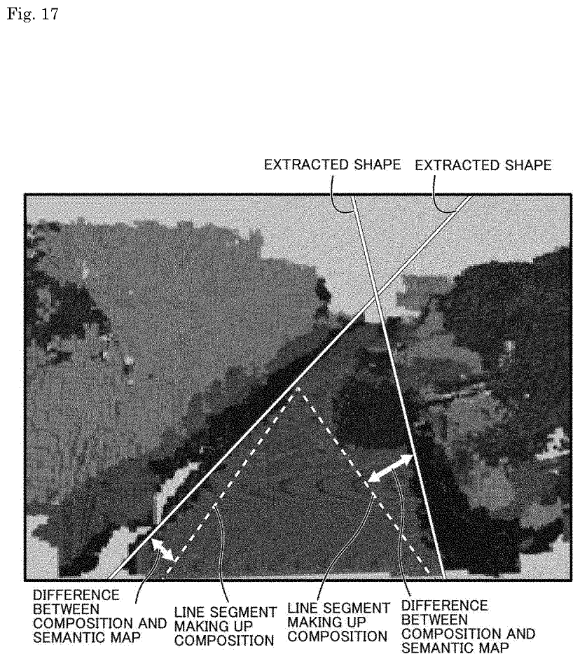

The difference illustrated in FIG. 17, between the shapes extracted in the semantic map as illustrated in FIG. 16A for example, and the line segments making up the set composition as illustrated in FIG. 16B, is calculated as cost. FIG. 17 is a state in which the semantic map and the composition are overlaid. In a case in which the difference between the shapes extracted in the semantic map and the line segments making up the composition is ideally 0, and the difference is 0, photography of an image matching the composition can be performed. However, in reality, bringing the difference to 0 is difficult, and accordingly there is a need to maximally reduce the different (reduce the cost) in order to photograph an image close to the set composition. Accordingly, there is a need to perform adjustment in which the difference between the line segments making up the composition and the nearest shapes thereto in the semantic map is smallest.

$${cost}_{comp k} = {\sum }_{i = 1}^{n} \frac{1}{{m}_{i}} {\sum }_{j = 1}^{{m}_{i}} {arg min}_{l} \frac{\vert {a}_{l} {x}_{j} + {b}_{l} {y}_{j} + {c}_{l} \vert}{\sqrt{{a}_{l}^{2} + {b}_{l}^{2}}} \qquad [ Math . 1 ]$$

The costₚₐₜₕ that is the cost of the tentative travel route is then calculated by the following Expression 2.

costₚₐₜₕ=w₁Σₖ₌₀^{p}cost_{comp k}+w₂cost_{dist}+w₃cost_{obs} [Math. 2]

The variables used in Expression 1 and Expression 2 are as follows.

Number of line segments included in composition: n

1st straight line detected by Hough transform: a₁+b₁+c₁=0

Optional point on i-th line segment: (xᵢ, yᵢ)

Cost obtained from position on certain route and attitude k: cost_{comp k}

Number of positions on route and attitudes: p

Cost obtained from distance to destination (waypoint): cost_{dist}

Cost obtained from distance to obstacle: cost_{obs}

Weights: w1, w2, w3

Next, in step S505, whether or not the calculated cost is not greater than a predetermined threshold value is determined. The cost is preferably low, and accordingly in a case in which the cost is not greater than the threshold value, the processing advances to step S506 (Yes in step S505), and the tentative travel route is decided to be the optimal local travel route.

Note that in a case in which there is a plurality of tentative travel routes of which the cost is not greater than the threshold value, the tentative travel route thereof of which the cost is the lowest is preferably decided to be the optimal local travel route.

Conversely, in a case in which the cost is greater than the threshold value, the processing advances to step S507 (No in step S505), and the tentative travel route is decided to not be the optimal local travel route, since the cost is great.

Local travel routes between the waypoints can all be decided in this way. The global travel route is made up of a plurality of local travel routes, and accordingly, once all local travel routes are decided, this means that the entire route for the mobile body 100 to perform photography has been decided. The information processing device 400 then transmits information of the decided travel route to the mobile body 100. Upon receiving the travel route information, the UAV control unit 101 of the mobile body 100 controls actions of the mobile body 100 following the travel route information, and further, the gimbal control unit 105 controls actions of the gimbal 500, whereby photography of the specified composition can be performed by autonomous photography by the mobile body 100 and the image-capturing device 200. Also, by displaying the created travel route on the display unit 305 of the terminal device 300 to be presented to the user, the user can comprehend what sort of travel route the mobile body 100 will travel over to perform photography.

According to the present technology, there is no need for a highly-skilled operator, which conventionally was necessary in photography using a mobile body 100 such as a drone.

### 2. Modifications

Although an embodiment of the present technology has been described in detail above, the present technology is not limited to the above-described embodiment, and various types of modifications can be made on the basis of the technical spirit of the present technology.

The drone serving as the mobile body 100 is not limited to an arrangement that has propellers as described in the embodiment, and may be a so-called fixed-wing type.

The mobile body 100 according to the present technology is not limited to being a drone, and may be an automobile, a ship, a robot, or the like, that is capable of automatically traveling without receiving human operations.

In a case in which the image-capturing device 200 is not mounted on the mobile body 100 by a camera mount having the functions of the gimbal 500, and is fixed in a constant state, the attitude of the mobile body 100 and the attitude of the image-capturing device 200 are the same. In this case, photography of the set composition may be performed by adjusting the tilt of the mobile body 100.

Although the mobile body 100 and the image-capturing device 200 are configured as separate devices in the embodiment, the mobile body 100 and the image-capturing device 200 may be configured as an integral device.

Any sort of equipment may be used as the image-capturing device 200 as long as it has image-capturing functions and can be mounted on the mobile body 100, such as a digital camera, a smartphone, a cellular phone, a mobile gaming device, a laptop computer, a tablet terminal, or the like.

The image-capturing device 200 may have the input unit 304, the display unit 305, and so forth. Also, the image-capturing device 200 may be an arrangement that can be used alone as the image-capturing device 200 when not connected to the mobile body 100.

Also, the three-dimensional map data used for semantic map creation may be acquired from an external server or a cloud, or data available to the public on the Internet may be used.

Also, semantic map creation may be performed by an automobile, robot, or ship on which the sensor unit 106 is mounted, or may be performed on foot by a user holding a sensor device, instead of by a drone.

The information processing device 400 may be provided to the mobile body 100 instead of the terminal device 300.

Also, an arrangement may be made in which, in a case of text input or audio input such as “want to photograph centered on humans” for example in the setting of the composition, analysis thereof is performed and a composition (e.g., a middle placement composition centered on people or the like) can be set or proposed.

Also, photography conditions such as exposure or the like may be adjusted in accordance with information of a subject obtained from the semantic map and the composition. An example is to change exposure of a range of a subject that can be understood to be sky, or the like.

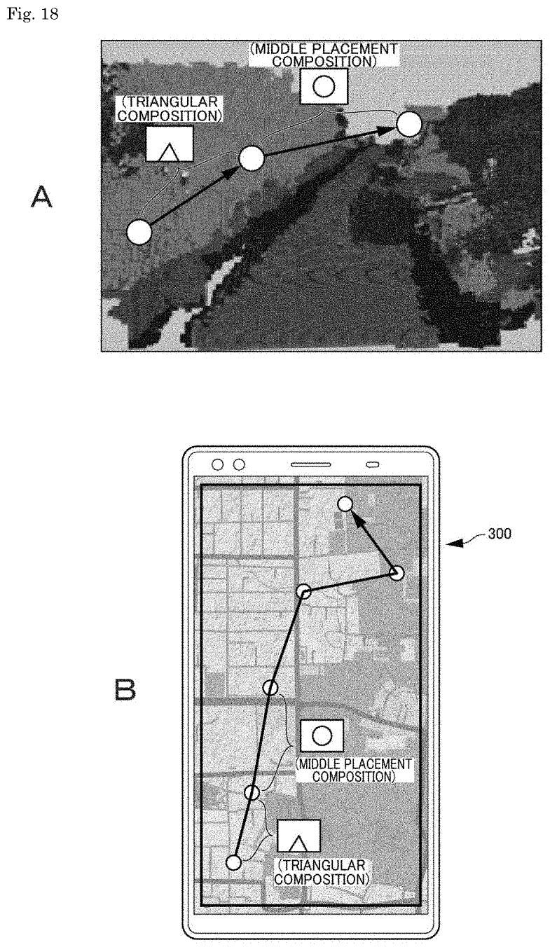

Although one composition is set and a travel route for performing photography by that composition is decided in the embodiment, an arrangement may be made in which different compositions can be set for each local travel route (each span between waypoints) or each optional position, as illustrated in FIG. 18. Note that the compositions illustrated in FIG. 18 are only exemplary, and these compositions are not limiting.

The composition setting unit 403 may reference moving images and still images of which photography has been completed, extract compositions from the reference moving images/still images, and automatically set compositions the same as in the moving images and the still images.

The present technology can also assume the following configurations.

(1)

An information processing device, including:

a map creating unit that creates a map of a travel range, which is a range over which a mobile body having an image-capturing device performs photography while travelling;

a shape extracting unit that extracts a shape present in the map;

a composition setting unit that sets a composition of an image to be photographed by the image-capturing device; and

a route deciding unit that decides a travel route in the travel range of the mobile body on the basis of the shape and the composition.

(2)

The information processing device according to (1), wherein the map is a semantic map.

(3)

The information processing device according to (1) or (2), wherein the route deciding unit decides a global travel route that is a travel route that passes through all of a plurality of waypoints set in the travel range.

(4)

The information processing device according to (3), wherein the route deciding unit decides a local travel route that is a travel route between the waypoints, on the basis of a cost calculated with respect to the composition and the travel route.

(5)

The information processing device according to (4), wherein the route deciding unit sets a plurality of tentative travel routes between each of the plurality of waypoints, calculates the cost for each of the plurality of tentative travel routes, and decides the tentative travel route of which the cost is low to be the local travel route.

(6)

The information processing device according to (4), wherein the cost is based on a difference between a shape extracted from the map by the shape extracting unit and a line segment making up the composition.

(7)

The information processing device according to (4), wherein the cost is based on, between the waypoints, a distance from the waypoint at one end side to the waypoint at another end side.

(8)

The information processing device according to (4), wherein the cost is based on, between the waypoints, a distance to an obstacle from the waypoint at one end side to the waypoint at another end side.

(9)

The information processing device according to of any one of (1) to (8), wherein the composition setting unit sets the composition on the basis of input from a user.

(10)

The information processing device according to claim 9, wherein a composition selected by the user input from a plurality of pieces of composition data set in advance is set as the composition.

(11)

The information processing device according to claim 9, wherein a shape input by drawing by the user is set as the composition.

(12)

The information processing device according to claim 9, wherein the user is presented with composition data similar to a shape extracted from the map by the shape extracting unit, and the composition data decided by input by the user is set as the composition.

(13)

The information processing device according to any one of (1) to (12), wherein the composition setting unit decides the composition on the basis of the shape extracted from the map.

(14)

The information processing device according to (3), wherein the composition is settable between each of the waypoints.

(15)

The information processing device according to any one of (1) to (13) wherein the shape extracting unit extracts the shape present in the map by Hough transform.

(16)

An information processing method, including:

creating a map of a travel range, which is a range over which a mobile body having an image-capturing device performs photography while travelling; extracting a shape present in the map;

setting a composition of an image to be photographed by the image-capturing device; and

deciding a travel route in the travel range of the mobile body on the basis of the shape and the composition.

(17)

An information processing program that causes a computer to execute an information processing method of

creating a map of a travel range, which is a range over which a mobile body having an image-capturing device performs photography while travelling,

extracting a shape present in the map,

setting a composition of an image to be photographed by the image-capturing device, and

deciding a travel route in the travel range of the mobile body on the basis of the shape and the composition.

### REFERENCE SIGNS LIST

100 Mobile body
200 Image-capturing device
400 Information processing device
401 Map creating unit
402 Shape extracting unit
403 Composition setting unit
405 Route deciding unit

1. An information processing device, comprising:
a map creating unit that creates a map of a travel range, which is a range over which a mobile body having an image-capturing device performs photography while travelling;
a shape extracting unit that extracts a shape present in the map;
a composition setting unit that sets a composition of an image to be photographed by the image-capturing device; and
a route deciding unit that decides a travel route in the travel range of the mobile body on the basis of the shape and the composition.

2. The information processing device according to claim 1,
wherein the map is a semantic map.

3. The information processing device according to claim 1,
wherein the route deciding unit decides a global travel route that is a travel route that passes through all of a plurality of waypoints set in the travel range.

4. The information processing device according to claim 3,
wherein the route deciding unit decides a local travel route that is a travel route between the waypoints, on the basis of a cost calculated with respect to the composition and the travel route.

5. The information processing device according to claim 4,
wherein the route deciding unit sets a plurality of tentative travel routes between each of the plurality of waypoints, calculates the cost for each of the plurality of tentative travel routes, and decides the tentative travel route of which the cost is low to be the local travel route.

6. The information processing device according to claim 4,
wherein the cost is based on a difference between a shape extracted from the map by the shape extracting unit and a line segment making up the composition.

7. The information processing device according to claim 4,
wherein the cost is based on, between the waypoints, a distance from the waypoint at one end side to the waypoint at another end side.

8. The information processing device according to claim 4,
wherein the cost is based on, between the waypoints, a distance to an obstacle from the waypoint at one end side to the waypoint at another end side.

9. The information processing device according to claim 1,
wherein the composition setting unit sets the composition on the basis of input from a user.

10. The information processing device according to claim 9,
wherein a composition selected by the user input from a plurality of pieces of composition data set in advance is set as the composition.

11. The information processing device according to claim 9,
wherein a shape input by drawing by the user is set as the composition.

12. The information processing device according to claim 9,
wherein the user is presented with composition data similar to a shape extracted from the map by the shape extracting unit, and the composition data decided by input by the user is set as the composition.

13. The information processing device according to claim 1,
wherein the composition setting unit decides the composition on the basis of the shape extracted from the map.

14. The information processing device according to claim 3,
wherein the composition is settable between each of the waypoints.

15. The information processing device according to claim 1,
wherein the shape extracting unit extracts the shape present in the map by Hough transform.

16. An information processing method, comprising:
creating a map of a travel range, which is a range over which a mobile body having an image-capturing device performs photography while travelling;
extracting a shape present in the map;
setting a composition of an image to be photographed by the image-capturing device; and
deciding a travel route in the travel range of the mobile body on the basis of the shape and the composition.

17. An information processing program that causes a computer to execute an information processing method of
creating a map of a travel range, which is a range over which a mobile body having an image-capturing device performs photography while travelling,
extracting a shape present in the map,
setting a composition of an image to be photographed by the image-capturing device, and
deciding a travel route in the travel range of the mobile body on the basis of the shape and the composition.
